(19) United States
(12) Patent Application Publication
(10) Pub. No.: US 2020/0140107 A1
(43) Pub. Date: May 7, 2020

(54) ENGINE MOUNTED AIRCRAFT GEARBOX DISPOSED IN PYLON

(71) Applicant: Gulfstream Aerospace Corporation, Savannah, GA (US)

(72) Inventors: Donald Freund, Savannah, GA (US); Douglas Klutzke, Savannah, GA (US); Michael Knight, Savannah, GA (US); Derek Muzychka, Savannah, GA (US)

(21) Appl. No.: 16/182,344

(22) Filed: Nov. 6, 2018

(51) Int. Cl. B64D 35/02; B64D 27/26; B64C 1/16; B64D 29/08; B64D 29/06

(52) U.S. Cl. CPC B64D 35/02; B64D 27/26; B64D 29/06; B64D 29/08; B64C 1/16

(57) ABSTRACT

An aircraft includes a fuselage, an engine, a pylon, a nacelle cowling, and a gearbox assembly. The engine is spaced apart from the fuselage and the pylon is disposed between the fuselage and the engine. The accessory gearbox is fixed to the engine and is at least partially disposed in the pylon.

### TECHNICAL FIELD

Embodiments of the present invention generally relate to aircraft and pylon assemblies for aircraft, and more particularly relate to aircraft and pylon assemblies in which an accessory gearbox is mounted to an engine and is disposed in a pylon.

### BACKGROUND OF THE INVENTION

Aircraft engines typically drive various accessories, such as fuel pumps, generators, hydraulic pumps, oil pumps, air turbine starters, and the like. These accessories are typically attached to a gearbox that conforms to the outer circumference of the engine within an engine housing or nacelle. These conventional gearboxes require nacelle diameters that accommodate both the engine and the gearbox.

Although these conventional gearboxes and nacelles are suitable for their intended purpose, the desire for improvement is essentially constant. In addition, various desirable features and characteristics will become apparent from the subsequent summary and detailed description, and the appended claims, taken in conjunction with the accompanying drawings and this background.

### SUMMARY

Various non-limiting embodiments of aircraft and assemblies for aircraft are disclosed herein.

In a first non-limiting embodiment, an aircraft includes, but is not limited to, a fuselage, an engine, a nacelle, a pylon, and a gearbox assembly. The engine is spaced apart from the fuselage and the pylon is disposed between the fuselage and the engine. The gearbox assembly is attached to the engine and is at least partially disposed in the pylon and/or fuselage

In a second non-limiting embodiment, an assembly includes, but is not limited to, an first pylon skin, a second pylon skin, and a gearbox assembly. The second pylon skin opposes the first pylon skin. The gearbox assembly is configured to be fixed to an engine and to be at least partially disposed between the first pylon skin and the second pylon skin.

### DESCRIPTION OF THE DRAWINGS

Advantages of the present embodiments will be readily appreciated as the embodiments becomes better understood by reference to the following detailed description, when considered in connection with the accompanying drawings wherein:

FIG. 1 is a front view illustrating a non-limiting embodiment of a portion of an aircraft in accordance with the teachings of the present disclosure; and

FIGS. 2-6 are simplified diagrams illustrating portions of the aircraft of FIG. 1 with components of a pylon assembly in accordance with the teachings of the present disclosure.

### DESCRIPTION OF EXEMPLARY EMBODIMENTS

The following detailed description is merely exemplary in nature and is not intended to limit the invention or the application and uses of the invention. Furthermore, there is no intention to be bound by any theory presented in the preceding background or the following detailed description.

The embodiments provided herein generally provide aircraft and pylon assemblies with engine mounted gearboxes disposed within pylons of the aircraft. The embodiments generally repackage an accessory gearbox from underneath the engine where conventional gearboxes are typically located to a side of the engine where the accessories fit within the pylon. In some embodiments, the gearbox may extend through the entire pylon into the fuselage of the aircraft. The accessory gearbox is positioned so that when the engine deflects under load during operation, the accessory gearbox does not contact plumbing, wiring, the pylon, or the fuselage. Axes of components within the gearbox may be longitudinally arranged, transversely arranged, radially arranged, or arranged in a different orientation with respect to the engine. In some embodiments, the accessory gearbox is substantially horizontally arranged within the pylon.

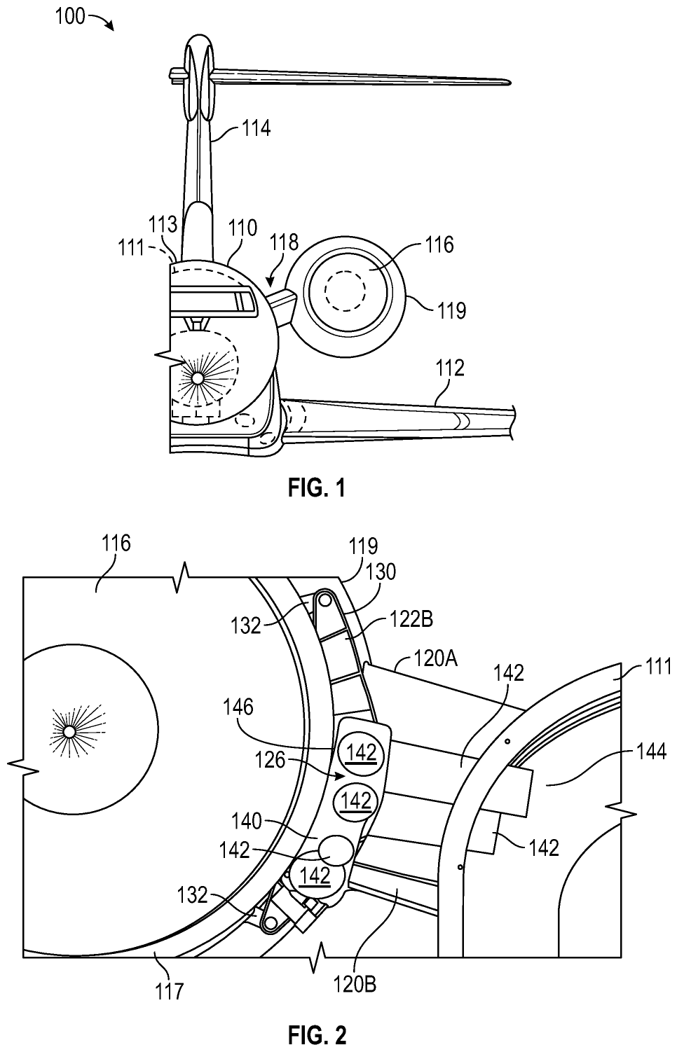

FIG. 1 illustrates a portion of a non-limiting embodiment of an aircraft 100. Aircraft 100 includes a fuselage 110, wings 112, a tail section 114, an engine 116, a nacelle cowling 119, and a pylon assembly 118. Fuselage 110 includes frame members 111, stringers/longerons (not illustrated), and skin sheets 113 secured to the frame members. As will be appreciated by those of ordinary skill in the art, fuselage 110 is the main body portion of aircraft 100 to which wings 112 and tail section 114 are mounted. Fuselage 110, wings 112, tail section 114, and engine 116 may have configurations different from those illustrated depending on the implementation and mission of the aircraft incorporating pylon assembly 118.

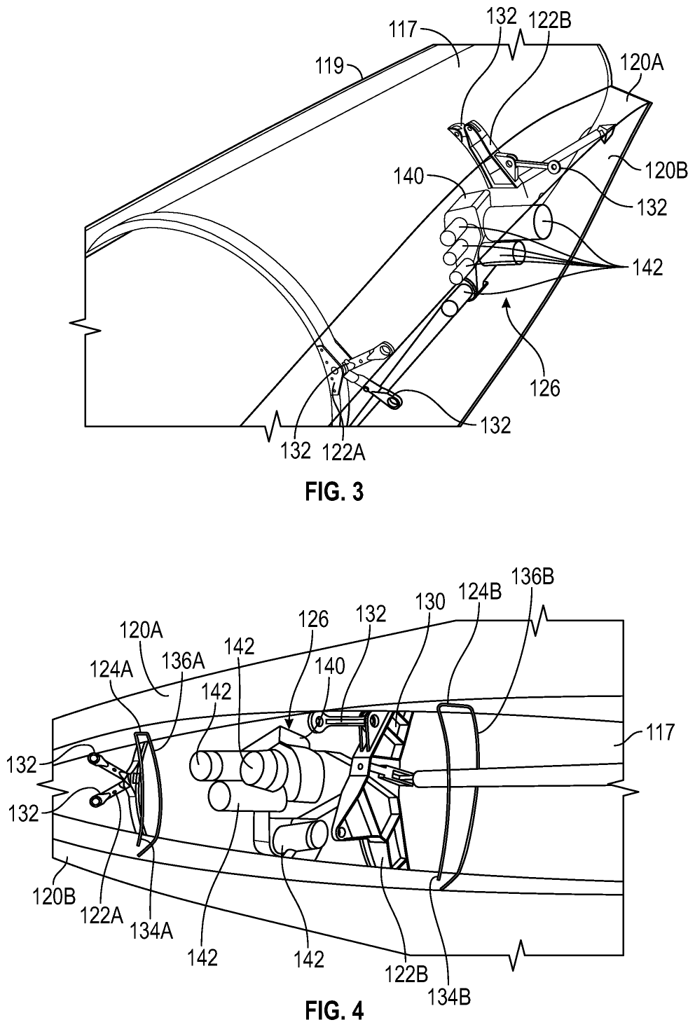

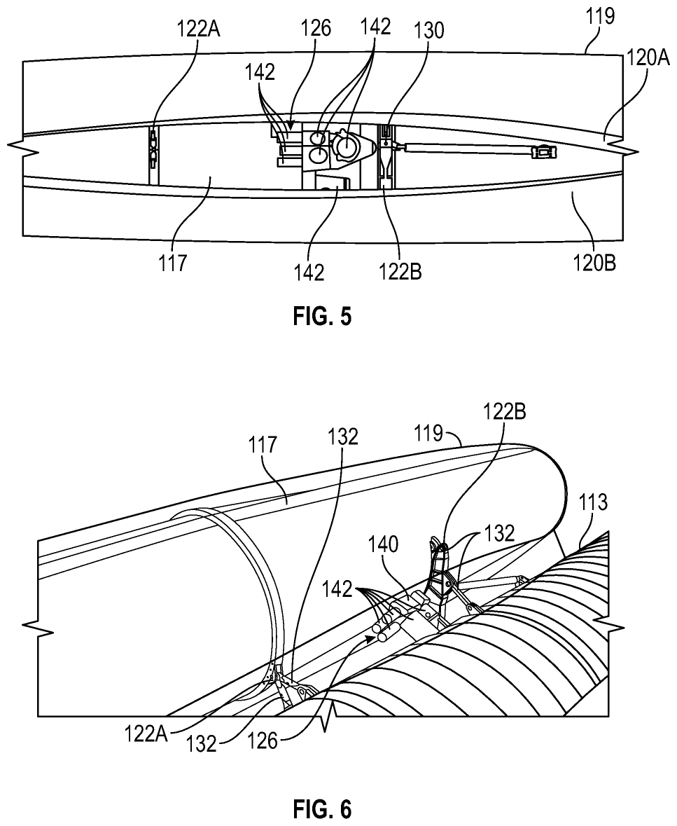

Referring now to FIGS. 2-6, and with continued reference to FIG. 1, portions of aircraft 100 are illustrated with components of pylon assembly 118. Engine 116 is surrounded by an engine casing 117 and a nacelle cowling 119. In the example provided, engine 116 is a turbofan jet engine mounted to and spaced apart from fuselage 110 by pylon assembly 118. In some embodiments, engine 116 is a different type of engine and is mounted to wings 112 and/or tail section 114. Engine 116 includes a radial power takeoff shaft (not illustrated) extending from the engine 116 towards gearbox assembly 126. As will be appreciated by those with ordinary skill in the art, the radial drive shaft transfers power to gearbox assembly 126 to drive various components of gearbox assembly 126.

Nacelle cowling 119 substantially circumscribes engine 116 and has a lateral dimension that is substantially similar to an outer dimension of engine 116. For example, nacelle cowling 119 may have a lateral dimension in a cross section perpendicular to a longitudinal direction of the nacelle cowling that is not enlarged to accommodate a conventional gearbox, as illustrated in FIG. 1 and FIG. 2. Accordingly, nacelle cowling 119 has reduced inlet lip and nozzle boat tail angles when compared with conventional cowlings that accommodate conventional gearboxes. As will be appreciated by those of ordinary skill in the art, the reduced inlet lip and nozzle boat tail angles result in favorable drag characteristics of nacelle cowling 119.

As used herein, the term “substantially circumscribes” means that nacelle cowling 119 circumscribes engine 116 except where pylon assembly 118 interrupts nacelle cowling 119. As used herein, the term “substantially similar to” means that nacelle cowling 119 has a shape that is based on the shape of engine 116 without radially expanded portions and increased inlet lip and nozzle boat tail angles that are required in conventional aircraft to incorporate conventional gearboxes underneath the engine. In other words, nacelle cowling 119 defines an inlet lip angle and a nozzle boat tail angle that are based on a dimension of engine 116 without a nacelle gearbox assembly (i.e., a gearbox assembly disposed within the nacelle instead of in the pylon).

Pylon assembly 118 includes an upper pylon skin 120A, a lower pylon skin 120B, engine mounts 122A and 122B, a first rib member 124A, a second rib member 124B, and an gearbox assembly 126. Upper pylon skin 120A and lower pylon skin 120B extend between fuselage skin sheets 113 and nacelle cowling 119 to form an outer surface of pylon assembly 118. As used herein, the term “pylon” refers to pylon skins 120A-B and the volume enclosed by pylon skins 120A-B between fuselage 110 and nacelle cowling 119.

In the example provided, engine mount 122B includes a mount yoke 130 and a mount link 132, and engine mount 122A includes mount links 132. Engine mounts 122A and 122B are fixed to engine casing 117 and to frame members 111 to secure engine 116 to fuselage 110. In the example provided, engine mounts 122A-B are made from a steel or a titanium material. In some embodiments, engine mounts 122A-B have different configurations that secure engine casing 117 to fuselage 110.

First rib member 124A (illustrated in FIG. 4) has a first end 134A fixed to fuselage 110 and a second end 136A separated from engine 116 in the pylon. Second rib member 124B has a first end 134B fixed to fuselage 110 and a second end 136B separated from engine 116 in the pylon. Rib members 124A-B maintain a contour of pylon skins 120A-B and transfer aerodynamic loads acting on the pylon back to frame members 111.

Gearbox assembly 126 includes an accessory gear box (AGB) 140 and a plurality of components 142. AGB 140 is a rigid material that is secured to engine casing 117 and serves as a base for mounting components 142. It should be appreciated that the number and location of components 142 varies by implementation. In the example provided, components 142 have individual housings that are each secured separately to AGB 140. In some embodiments, several components 142 may be grouped together in common housings. AGB 140 and components 142 collectively define a shape of gearbox assembly 126. The shape of gearbox assembly 126 is elongated with a first longitudinal end 144 opposing the fuselage and a second longitudinal end 146.

Gearbox assembly 126 is fastened to engine 116 through engine casing 117 at two or more attach points at an interior lateral side of engine casing 117. As used herein, the term “fastened” means connected by a structure that is configured to restrict relative rigid-body rotation and translation between the connected components. By securing to engine 116 rather than to fuselage 110 or the pylon, gearbox assembly 126 may be driven by a radial drive shaft from engine 116. For example, if gearbox assembly 126 were instead fastened to fuselage 110 or the pylon, then power transmission to gearbox assembly 126 would increase in complexity and would need to accommodate relative deflection between engine 116 and gearbox assembly 126. Such accommodation may involve less precisely meshing gear teeth, which may result in increased gear operating noise, reduced power transfer efficiency, and/or reduced reliability. Furthermore, additional safety measures for pylon or fuselage mounted assemblies may be required to protect from a failed axial transmission shaft that may flail and damage engine mounts or other neighboring components.

In the example provided, gearbox assembly 126 is at least partially disposed in the pylon and at least partially disposed within fuselage 110. For example, gearbox assembly 126 may extend through frame members 111 and stringers/longerons into fuselage 110, as illustrated in FIG. 2. In some embodiments, gearbox assembly 126 is entirely disposed in the pylon.

Gearbox assembly 126 is separated from and is between first rib member 124A and second rib member 124B. Furthermore, gearbox assembly 126 is free of attachment to and is separated from fuselage 110 and the pylon. In other words, gearbox assembly 126 is secured only to engine 116 through engine casing 117. Accordingly, accessory gearbox moves with engine 116 if any relative deformation or other deflection occurs between engine 116 and fuselage 110 under operational load. In the example provided, the longitudinal dimension of gearbox assembly 126 is generally parallel to a radius of engine 116. It should be appreciated that the orientation of gearbox assembly 126 varies by implementation and the shape of the pylon.

Components 142 include fuel pumps, generators, hydraulic pumps, oil pumps, air turbine starters, and the like. Some of components 142 have an axis of rotation that is substantially radially arranged relative to an axis of rotation of engine 116, some of components 142 have an axis of rotation that is substantially parallel to an axis of rotation of the engine, and some of components 142 have an axis of rotation that is transversely arranged relative to an axis of rotation of the engine, as can be seen in the various views. As will be appreciated by those with ordinary skill in the art, components 142 may have other orientations without departing from the scope of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft, comprising:
a fuselage;
an engine spaced apart from the fuselage
a nacelle cowling surrounding the engine;
a pylon disposed between the fuselage and the engine; and
a gearbox assembly fixed to the engine and at least partially disposed in the pylon.

2. The aircraft of claim 1, further comprising:
a first rib member having a first end fixed to the fuselage and a second end separated from the engine in the pylon;
a second rib member having a first end fixed to the fuselage and a second end separated from the engine in the pylon; and
a flexible seal between the pylon and the nacelle cowling to permit relative motion,
wherein the gearbox assembly is at least partially disposed in the pylon separated from and between the first rib member and the second rib member;

3. The aircraft of claim 1, wherein the nacelle cowling defines an inlet lip angle and a nozzle boat tail angle that are based on a dimension of the engine without a nacelle gearbox assembly.

4. The aircraft of claim 2, wherein the gearbox assembly includes an accessory gearbox and a plurality of accessories mounted to the accessory gearbox.

5. The aircraft of claim 1, wherein the gearbox assembly is at least partially disposed within the fuselage.

6. The aircraft of claim 1, wherein the gearbox assembly is free of attachment to and is separated from the fuselage and the pylon.

7. The aircraft of claim 1, wherein the gearbox assembly has an attachment portion to the engine, and wherein the gearbox assembly is fastened to the engine at a plurality of attachment portions.

8. The aircraft of claim 7, wherein the gearbox assembly has an elongated shape with a first longitudinal end opposing the fuselage and a second longitudinal end defining the first attachment portion and the second attachment portion.

9. The aircraft of claim 1, wherein the gearbox assembly includes a plurality of components, and wherein the plurality of components each have an axis of rotation that is substantially normal relative to an axis of rotation of the engine.

10. The aircraft of claim 1, wherein the gearbox assembly includes a plurality of components, and wherein the plurality of components each have an axis of rotation that is substantially parallel to an axis of rotation of the engine.

11. The aircraft of claim 1, wherein the gearbox assembly includes a plurality of components, and wherein the plurality of components each have an axis of rotation that is transversely arranged relative to an axis of rotation of the engine.

12. The aircraft of claim 1, wherein the gearbox assembly is entirely disposed in the pylon.

13. The aircraft of claim 1, wherein the gearbox assembly is fixed to the engine at an interior lateral side of the engine.

14. An assembly for an aircraft, the assembly comprising:
a first pylon skin;
a second pylon skin opposing the first pylon skin to define a pylon; and
a gearbox assembly configured to be fixed to an engine and to be at least partially disposed between the first pylon skin and the second pylon skin.

15. The assembly of claim 14, further comprising:
a first rib member having a first end configured to be fixed to a fuselage and a second end configured to be separated from the engine in the pylon; and
a second rib member having a first end configured to be fixed to the fuselage and a second end configured to be separated from the engine in the pylon;
wherein the gearbox assembly is configured to be at least partially disposed in the pylon separated from and between the first rib member and the second rib member.

16. The assembly of claim 14, wherein the gearbox assembly is configured to be at least partially disposed within a fuselage of the aircraft.

17. The assembly of claim 14, wherein the gearbox assembly is configured to be free of attachment to and to be separated from a fuselage, the first pylon skin, and the second pylon skin.

18. The assembly of claim 14, wherein the gearbox assembly has a first attachment portion and a second attachment portion, and wherein the gearbox assembly is configured to be fastened to the engine at the first attachment portion and the second attachment portion.

19. The assembly of claim 18, wherein the gearbox assembly has an elongated shape with a first longitudinal end configured to oppose a fuselage and a second longitudinal end defining the first attachment portion and the second attachment portion.

20. The assembly of claim 14, wherein the gearbox assembly has a longitudinal dimension that is substantially parallel with a radius of the engine.
